(19) United States
(12) Patent Application Publication
(10) Pub. No.: US 2006/0046008 A1
(43) Pub. Date: Mar. 2, 2006

(54) Method for coating the outer side of a sanitary outlet part, and corresponding sanitary outlet part

(75) Inventor: Fabian Wildfang, Badenweiler (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: NEOPERL GMBH, MULLHEIM (DE)

(21) Appl. No.: 10/524,489

(22) PCT Filed: Dec. 17, 2003
(86) PCT No.: PCT/EP03/14391

§ 371 Date: Aug. 24, 2005

(30) Foreign Application Priority Data
Feb. 21, 2003 (DE) 103 07 386.8

(51) Int. Cl. F16L 11/04; B32B 15/04

(52) U.S. Cl. 428/36.91; 428/457; 428/195.1; 156/230

(57) ABSTRACT

The present invention relates to a method for the external coating of a plastic part that surrounds the armature outlet of a sanitary outlet armature. The present invention also relates to an outlet part that surrounds the armature outlet of a sanitary outlet armature. The characterizing feature of the present invention is that the outlet part is manufactured as a plastic part that bears on its outside, at least in a partial area, at least one layer of an adhesive film or hot-stamping film. The present invention enables an economical coating of a sanitary outlet part, this coating being distinguished by its long life span.

### BACKGROUND

The present invention relates to a method for the coating the outer side of a plastic part that surrounds the armature outlet of a sanitary outlet armature. The present invention also relates to an outlet part that surrounds the armature outlet of a sanitary outlet armature.

Most sanitary outlet armatures have, in the area of their armature outlet, an outlet mouth or similar outlet part that is fastened releasably to the outlet armature and that surrounds the armature outlet. Such outlet mouths are already known in many embodiments. Materials used for them up to now have included metal, for example steel or brass, and plastic, such as for example ABS or polycarbonate. In order to adapt the external appearance of the outlet mouth to the outlet armature on which the outlet mouth is mounted, the outlet mouth is provided with a coating. For metals, the coating takes place through the galvanic application of other metals, such as for example chromium. A coating using baked enamel, or plasma coating, is also possible. Both methods have the disadvantage that on the one hand they are very time- and cost-intensive, and on the other hand they make a partial coating of the base material difficult or impossible. A partial coating is desirable if for example the screw threading of the outlet mouth, or recesses, or perforations on the outside are not supposed to be coated along with the rest of the part.

In the case of plastic, a coating with for example lacquer is possible. Here as well, the partial coating of the base material is very expensive, because the parts that are not to be coated must be previously masked. Moreover, the lacquer does not have a long life span, because lacquer and plastic have different coefficients of thermal expansion, so that cracks can arise in the paint after some time.

Likewise, it is possible to plate with chromium a sanitary outlet part made of plastic; however, only a comparatively limited number of suitable and correspondingly expensive plastics are available for this.

### SUMMARY

The object therefore arises of creating a method for coating a sanitary outlet part, as well as an outlet part, of the type mentioned above, that allow an economical coating of such an outlet part and at the same time are also distinguished by a long-lived coating.

The solution according to the present invention of this problem provides, in particular in the method of the above-noted type, that at least one coat of an adhesive film or hot-stamping film is applied on the outside of the plastic part.

In the outlet part mentioned above, the solution according to the present invention is in particular that the outlet part is manufactured as a plastic part that bears externally, at least in a partial area, at least one layer of an adhesive film or hot-stamping film.

### DETAILED DESCRIPTION OF THE PREFERRED EMBODIMENT

The present invention provides that at least one layer of an adhesive film or hot-stamping film is applied externally, at least in a partial area, on the outlet part, made of plastic material, that surrounds the armature outlet. Such adhesive or hot-stamping films, which can be made up for example of a thin layer of a heat-sealing adhesive, a metallization applied thereon, a protective lacquer, or a coloring layer made for example of transparent enamel, a separation layer made for example of wax, and a carrier material that is required for the application of these layers and is preferably made of a polyester film, can be manufactured economically by, for example, applying a chromium layer or a similar metallization onto a heat-sealing adhesive. Depending on the material applied onto the heat-sealing adhesive, the outlet part can be provided with various designs. For someone not skilled in the art, it is not immediately recognizable whether a coating of this sort has been executed immediately by a galvanic process or for example using a hot-stamping film.

Films of this sort can be applied easily to a surface that is flat in one direction or is slightly curved in one direction. The coating of the outside of an outlet part having a cylindrical shape is therefore unproblematically possible. In contrast to galvanic coatings, it is possible to leave partial surfaces uncoated during the coating, because for example recesses or perforations in the flat or slightly curved surface are not coated when the film, which runs parallel to the surface of the outlet part and is likewise flat, is rolled onto the cylindrical outer surface of the outlet part.

In order to enable an outlet part to be coated in this way, the outlet part is placed on a mandrel, and the outer area that is to be coated, and that is preferably fully cylindrical, of the outlet part is pressed against the selected hot-stamping film, and is rolled off. Due to a heated stamp situated behind the hot-stamping film, the heat-sealing adhesive and the plastic surface of the outlet part, which is made of plastic, are melted together and connected fixedly to one another.

The layer or layers applied onto the plastic surface of the outlet part are distinguished by their mechanical resistance to abrasion, for example against abrasive powder or the abrasive action of a household sponge, and by their chemical resistance to the acids of decalcification agents, as well as by their resistance to water and temperature.

A preferred development according to the present invention provides that in order to produce a chromed, aluminum, or similar metallic appearance, the at least one layer is realized as a metallic layer in at least one partial area of a plastic part.

It is useful if at least one metallic and/or colored layer is applied onto the external side of the plastic part by means of an adhesive layer, in particular a heat-sealing adhesive layer. Here it is also possible for at least one layer of an adhesive or hot-stamping film to be applied at least on a partial area of the outer circumference of the plastic part. During the application of the layer or layers, it can be advantageous if at least one layer of an adhesive or hot-stamping film is applied so that it wraps around the outer circumference of the plastic part at least once. In this way, the two ends of the wrapping formed by the layer of film can either overlap slightly or else can meet one another directly at opposed abutting edges. These abutting edges can be made so as to be practically invisible to someone not skilled in the art, due to the small thickness of the layers.

When a plurality of layers are applied one over the other, it is useful if these layers surround the outside of the outlet mouth in at least two wrappings that are situated one over the other and in particular are connected to one another. In this way, an abutting edge arises only at the end of the wrapping; moreover, a plurality of layers can be applied onto the outlet part in one operation. Likewise, it is conceivable that a plurality of wrappings with a different coating are connected to one another and are applied onto the outlet part in one operation.

In addition to, or instead of, a layer on the outer circumference of the plastic outlet part, it can be useful if at least one layer of an adhesive film or hot-stamping film is applied at least on the end of the plastic part at the flow outlet side. In this way, a metallizing or colored layer can be applied both on the outer circumference and also on the end of an outlet part at the flow outlet side.

Here it is particularly advantageous if at least one of the layers applied onto the plastic part can be printed on or otherwise inscribed. Such an inscription can likewise be carried out in the hot-stamping method by using a corresponding arm to press on a colored hot-stamping film, by using an additional coated heat transfer film made of transparent material, or by laser inscription of the layer or layers applied by means of the adhesive or heat-sealing film.

In particular in the last two cases mentioned, it is advantageous if at least one external transparent or protective layer is applied onto a layer, in particular a printed or similarly inscribed layer; this reduces the corrosion points formed by the inscription, and provides a long-lasting securing of the inscription of the outlet part.

A preferred specific embodiment of the present invention provides that the external transparent or protective layer is formed as a protective film. However, it is also possible that only a transparent protective layer is deposited or applied onto the inscription by means of a heat-sealing adhesive.

A particularly advantageous development of the present invention, warranting separate protection, provides that the outlet part is formed as a jet regulator housing in which a jet fractionating device and/or a jet regulating device and/or a flow rectifier are provided. In this specific embodiment, the otherwise standard outlet mouth on the one hand, and the required jet regulator housing on the other hand, can be combined in a unified outlet part that can be fastened releasably to the sanitary outlet armature, which makes the assembly and also the later maintenance easier, because fewer individual parts must be fashioned to the outlet armature. It is also of particular advantage that in such a specific embodiment the usable inside flow cross-section of the jet regulator can be larger.

However, instead of this it is also possible for the outlet part to be designed as an outlet mouth that can be connected to the sanitary outlet armature, preferably in releasable fashion.

1. Method for external coating of a plastic part that surrounds the armature outlet of a sanitary outlet armature, comprising applying at least one layer of an adhesive film or hot-stamping film onto an outside of the plastic part.

2. Method according to claim 1, wherein in order to produce a chromium, aluminum, or similar metallic appearance, the method further comprises forming the at least one layer as a metallic layer in at least one partial area of the plastic part.

3. Method according to claim 1, wherein the at least one layer comprises at least one metallic and/or colored layer that is applied onto the outside of the plastic part using an adhesive layer in the form of a heat-sealing adhesive layer.

4. Method according to claim 1, wherein the at least one layer of the adhesive film or hot-stamping film is applied at least onto a partial area of an outer circumference of the plastic part.

5. Method according to claim 4, wherein the at least one layer of the adhesive film or hot-stamping film is applied onto the outer circumference of the plastic part so as to wrap around it at least once.

6. Method according to claim 1, wherein the at least one layer of the adhesive film or hot-stamping film is applied at least onto an end of the plastic part at a flow outlet side.

7. Method according to claim 1, wherein at least one of the layers applied onto the plastic part is printed on or inscribed.

8. Method according to claim 7, wherein at least one external transparent layer or protective layer is applied onto the printed or inscribed layer of the adhesive film or hot-stamping film.

9. Method according to claim 8, wherein the external transparent or protective layer is formed as a protective film.

10. Outlet part, formed by the method of claim 1, that surrounds the armature outlet of a sanitary outlet armature, the outlet part is manufactured as the plastic part that bears on its outside, at least in a partial area, the at least one layer of the adhesive film or hot-stamping film.

11. Outlet part according to claim 10, wherein the at least one layer for producing a chromium, aluminum, or similar metallic appearance is constructed as a metallic layer in at least one partial area of the plastic part.

12. Outlet part according to claim 10, wherein the at least one metallic and/or colored layer is applied onto the outside of the plastic part by an adhesive layer a heat-sealing adhesive layer.

13. Outlet part according to claim 10, wherein the at least one layer of the adhesive film or hot-stamping film is applied at least onto a partial area of the outer circumference of the plastic part.

14. Outlet part according to claim 10, wherein the at least one layer of the adhesive film or hot-stamping film is applied onto the outer circumference of the plastic part so as to wrap around it at least once.

15. Outlet part according to claim 10, wherein the at least one layer of the adhesive film or hot-stamping film is applied at least onto an end of the plastic part at the flow outlet side.

16. Outlet part according to claim 10, wherein at least one of the layers applied on the plastic part is printed on or inscribed.

17. Outlet part according to claim 16, wherein at least one external transparent layer or protective layer is applied onto the printed or inscribed layer of the adhesive film or hot-stamping film.

18. Outlet part according to claim 17, wherein the external transparent or protective layer is formed as a protective film.

19. Outlet part according to claim 10, wherein the outlet part is formed as a jet regulator housing in which a jet fractionating device and/or a jet regulating device and/or a flow rectifier are provided.

20. Outlet part according to claim 10, wherein the outlet part is formed as an outlet mouth that can be connected to the sanitary outlet armature in releasable fashion.
